(19) United States
(12) Patent Application Publication
(10) Pub. No.: US 2008/0217949 A1
(43) Pub. Date: Sep. 11, 2008

(54) Powered Tailgate Ramp

(76) Inventors: Michael D. Kobrehel, Elkhart, IN (US); Jeffrey D. Mikenas, Valparaiso, IN (US); Craig J. Reske, Niles, MI (US)

Correspondence Address: QUARLES & BRADY LLP, 411 E. WISCONSIN AVENUE, SUITE 2040, MILWAUKEE, WI, 53202-4497, US

(21) Appl. No.: 11/969,016

(22) Filed: Jan. 3, 2008

Related U.S. Application Data
(60) Provisional application No. 60/894,065, filed on Mar. 9, 2007.

(51) Int. Cl. B62D 33/03

(52) U.S. Cl. 296/61

(57) ABSTRACT

A tailgate ramp for a vehicle is driven up and down by a rotary drive system that engages a hinge plate. The prime mover of the system is a two way electric motor that drives the hinge plate through a gear reduction, and can be placed away from the gate using parallel shafts that extend between the motor and the hinge plate. A screw driven latch arm is also driven by a two way electric motor to latch and unlatch the door.

### CROSS-REFERENCE TO RELATED APPLICATION

This claims the benefit of U.S. provisional application 60/894,065, filed on Mar. 9, 2007.

### STATEMENT CONCERNING FEDERALLY SPONSORED RESEARCH OR DEVELOPMENT

Not applicable.

### FIELD OF THE INVENTION

This invention relates to doors for vehicles, and in particular to a tailgate of a vehicle such as a trailer, motor home or delivery vehicle that when opened serves as a ramp from the ground into the vehicle.

### BACKGROUND OF THE INVENTION

Vehicles such as motor homes, trailers and delivery vehicles sometimes have a rear opening door that also serves as a ramp. The door typically has a substantial hinge mechanism to operate the door. The door can be large, for example eight feet wide and seven to nine feet tall, and heavy. Most systems, both powered and manual, are counterbalanced with torsion springs wrapped around the door hinge or with tension springs tending to pull the door closed. These springs store energy when the door is lowered and assist in the raising of the door when it is closed. The assist provided by the springs allows the operator to manually lift the door if necessary, which could weigh as much as 350 pounds or more.

Typical power systems for opening and closing such tailgates use a cable or cable and drum method of lifting the door. The cable is attached near the outer edge of the door and the power unit is mounted high inside the box of the vehicle. The exposed cable attaches to the outer edge of the door when the door is lowered and can present a tripping or other hazard if someone tries to enter or exit the vehicle from the side of the door.

### SUMMARY OF THE INVENTION

The invention provides a tailgate hinge for a vehicle that has a tailgate that doubles as a ramp when the tailgate is open. The tailgate is hinged to the vehicle chassis at a lower edge of the tailgate to pivot about a horizontal pivot axis. The door is driven by a rotary mechanism to pivot about the pivot axis so as to rotate the tailgate open and closed. The mechanism for pivoting the door includes an output shaft engaged with the door, a driven element coupled to the output shaft and a driver element in driving engagement with the driven element, the driver element being driven by a prime mover.

In a preferred form, the driven element and the driver element are gears in meshing engagement with each other and the prime mover is a rotary motor that drives the driver gear in both directions, to either open or close the door.

In another useful aspect, there are hinge plates on both sides of the tailgate and both hinge plates are driven by the same prime mover. The prime mover can be an electric motor and can include gear reduction.

In another preferred aspect, when the tailgate is closed, a power latch holds the tailgate closed. The power latch in a useful form includes a screw engaged with a nut that rotates a lever to either latch the door or unlatch it.

In a preferred form, a first shaft engages the tailgate to rotatably drive the tailgate so as to close the tailgate and a second shaft is provided forward of the first shaft and parallel to the first shaft that is in driving engagement with the first shaft and is driven by a prime mover so as to drive the first shaft. In this aspect, the prime mover is preferably fixed to the vehicle chassis generally in the center of the chassis, forward of the tailgate and below the compartment of the vehicle.

In a second embodiment of the invention, the mechanism for pivoting the door includes a linkage assembly engaged with the hinge plate.

In another embodiment, the mechanism includes an arm attached to the door and a linkage driven by the rotary mechanism to actuate the arm.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is perspective view of the rear of a vehicle having a tailgate ramp incorporating the invention;

FIG. 2 is a rear plan view of the hinge portion of the vehicle of FIG. 1;

FIG. 3 is a detail view of the right side portion of FIG. 2;

FIG. 4 is a cross-sectional view from the plane of the line 4-4 of FIG. 3;

FIG. 5 is a cross-sectional view from the plane of the line 5-5 of FIG. 3;

FIG. 6 is a cross-sectional view from the plane of the line 6-6 of FIG. 3;

FIG. 7 is a view like FIG. 6, but with the tailgate open;

FIG. 8 is a cross-sectional view from the plane of the line 8-8 of FIG. 3;

FIG. 9 is a fragmentary perspective view showing the engagement of the drive system with the hinge;

FIG. 10 is a view from the inside of the vehicle looking out of a latch for the tailgate when closed;

FIG. 11 is a cross-sectional view from the plane of the line 11-11 of FIG. 10 with the latch unlatched;

FIG. 12 is a view like FIG. 11 with the latch latched;

FIG. 13 is a rear plan view of the hinge portion of a second embodiment of the present invention;

FIG. 14 is a perspective view of the drive system of the second embodiment of the present invention;

FIG. 15 is a cross-sectional view from the plane of the line 15-15 of FIG. 13;

FIG. 16 is a view like FIG. 15, but with the tailgate open;

FIG. 17 is a top plan view of the drive system of FIG. 14;

FIG. 18 is a cross-sectional view of a second embodiment of a latch mechanism;

FIG. 19 is a cross-sectional view of the second embodiment of the latch mechanism of FIG. 18;

FIG. 20 is a cross-sectional view of the second embodiment of the latch mechanism of FIG. 18;

FIG. 21 is a cross-sectional view of a third embodiment of a latch mechanism;

FIG. 22 is a side plan view of the third embodiment of the latch mechanism of FIG. 21; and

FIG. 23 is an exploded perspective view of a torsion spring universal joint used in the present invention.

### DETAILED DESCRIPTION OF THE PREFERRED EMBODIMENT

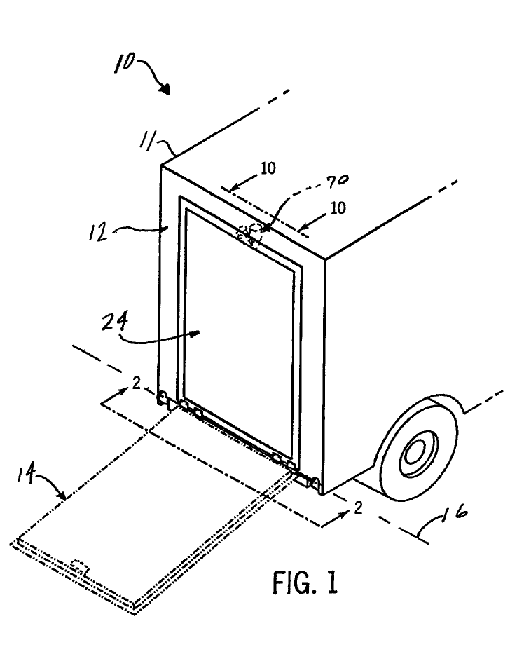

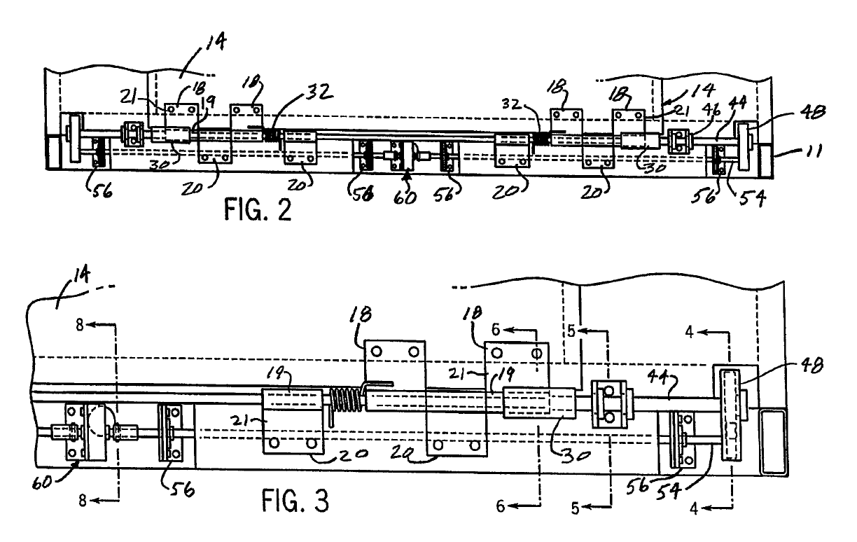

Referring to FIG. 1, a vehicle 10 which could be a trailer or a motor home for example, has a rear end 12 that is closed or opened with a tailgate 14. The tailgate 14 is hinged at its lower edge to the vehicle 10 to pivot about axis 16. Referring to FIGS. 2 and 3, the hinge that connects the tailgate 14 to the vehicle 10 includes upper hinge plates 18 and lower hinge plates 20 that alternate, with the hinge plates 18 fastened to the lower edge of the tailgate 14 and the hinge plates 20 fastened to the lower edge of an opening 24 that the tailgate 14 closes. A hinge pin 26 connects the hinge plates 18 and 20 so that the hinge plates 18 are pivotable about axis 16 relative to the hinge plates 20.

The hinge plates 18 and 20 may be of a rolled construction or be of an extruded construction. In either case, each of the hinge plates 18 and 20 has a tubular portion 19 through which the hinge pin 26 extends and a generally flat or plate portion 21 which is secured to the respective tailgate 14 or vehicle chassis 11. The plate portions of the hinge plates 18 are flat on their sides that get bolted against the tailgate 14 whereas the plates 20 may be formed with a spacer section 28 that creates a space in-between the tubular portion of the hinge plates 18 and 20 and the rear surface of the chassis 11 against which the plates 20 are fastened. Alternatively, the plates 20 could be the same as the plates 18, and a separate spacer provided, or another configuration could be provided so that there is room to slip a slotted, tubular coupling 30 onto the end plate 18 as further described below. Torsion springs 32 are preferably provided around the hinge pin 26 with one end that presses against one of the hinge plates 18 or against the tailgate 14 and the opposite end pressing against one of the plates 20 or against the chassis 11, so the space provided by the spacer section 28 also makes room for the springs 32. The torsion springs 32 bias the tailgate into the closed position to make the tailgate easier to lift when closing and opening.

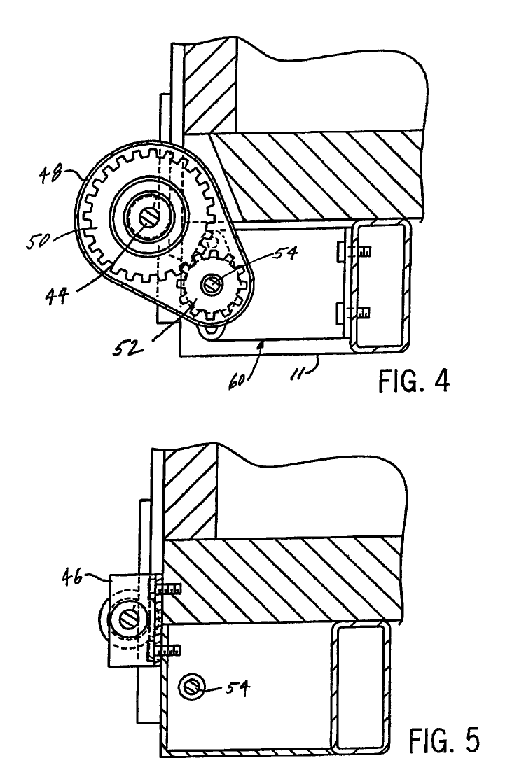

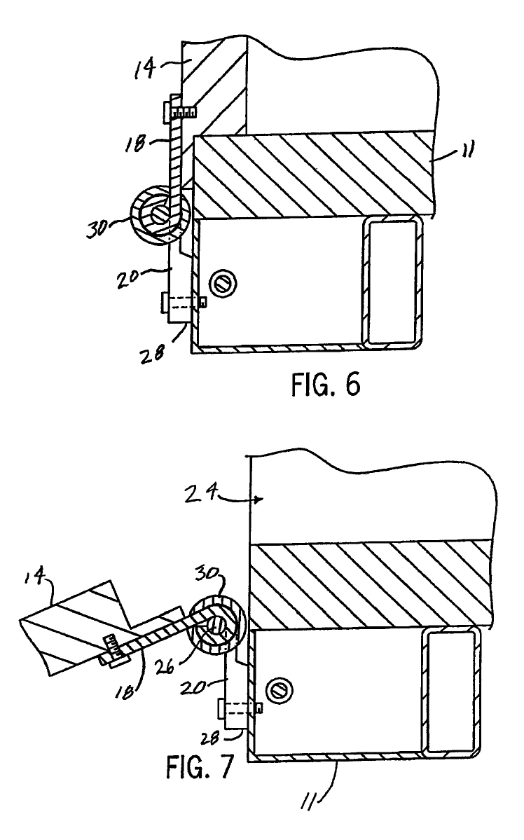

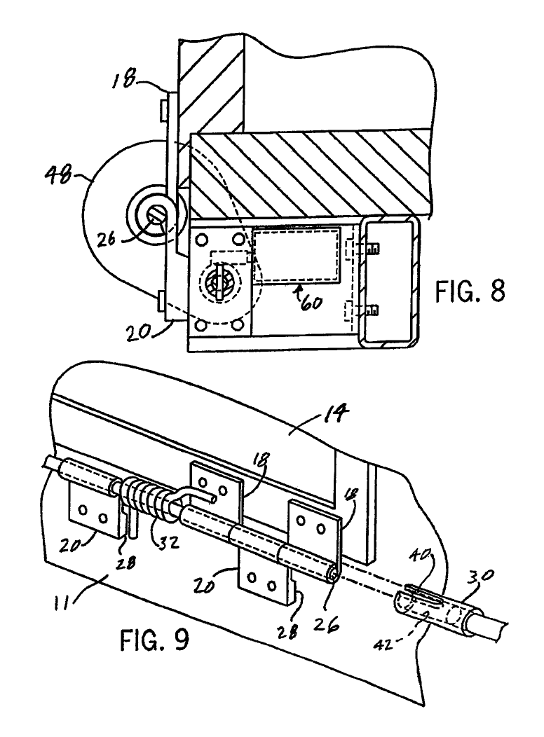

As mentioned above and shown in FIG. 9, slotted tubular coupling 30, one on each side of the tailgate 14, engages the end hinge plate 18 on that side with the plate part 21 of the hinge 18 fitting in a slot 40 and the tubular part 19 of the hinge 18 being received in the lumen 42 of the coupling 30. Thus, the coupling 30 is able to impart rotary motion to the hinge plate 18 about the axis 16. Coupling 30 is fixed to shaft 44 which is journaled in bracket 46, bolted to the chassis 11. As many journals 46 may be provided for each of the shafts 44 as are required for stability. Shaft 44 is journaled by suitable bearings in gear housing 48 and is secured by welding, a keyway, splines, or other suitable connection to a driven gear 50 (FIG. 4). Gear 50 is in meshing engagement with driving gear 52 which is connected by welding, splines, a keyway, or other suitable means to shaft 54. Alternatively, gears 52 and 50 could be replaced by a chain and sprocket set. Referring to FIG. 2, shaft 54 is journaled in brackets 56 which are fastened to the chassis 11. In approximately the middle portion of the chassis 11, the ends of the two shafts 54 are coupled to the drive shaft of a motor gear unit 60 that has a shaft coming out of both sides thereof, the motor gear unit 60 is secured to the chassis 11 and drives the shafts 54 in one direction to open the tailgate 14 and in the opposite direction to close the tailgate 14.

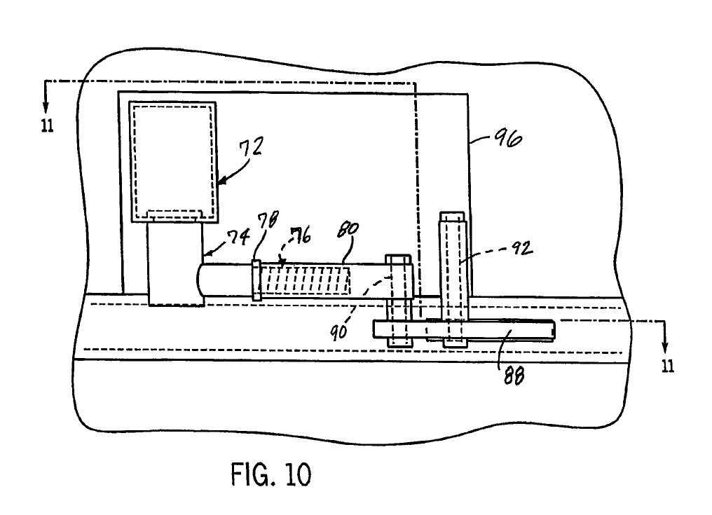

Referring to FIGS. 1 and 10-12, a latch 70 is centrally located at the top of the opening for latching the tailgate 14 closed. Like the drive system that opens and closes the tailgate 14, the latch 70 is also powered by an electric motor. Referring particularly to FIGS. 10-12, the motor gear box unit 72 includes a right angle drive, which could be a worm gear drive or a bevel gear drive 74, that drives a lead screw 76 that is in threaded engagement with a nut 78 that is fixed to a tube member 80. Turning the screw 76 threads it into or out of the nut 78 to vary the length of the combined screw 76 and member 80, in other words, the distance between the axis 84 of the motor, which is the axis about which the screw 76 rotates, and the axis 86 which is the axis about which a locking arm member 88 rotates relative to the member 80. Locking arm 88 is pivotally connected to member 80 with a post 90 fixed to an inner end of the element 88 and extending through a hole in the end of member 80 so as to establish a pivoting connection. Locking element 88 is pivotally connected via another post 92 that is fixed to it and received in a tube 94 that is fixed relative to the chassis 11 so as to establish a pivoting connection with the post 92. The entire latching assembly 70 may be secured to a base plate 96 which is itself secured to the chassis 11.

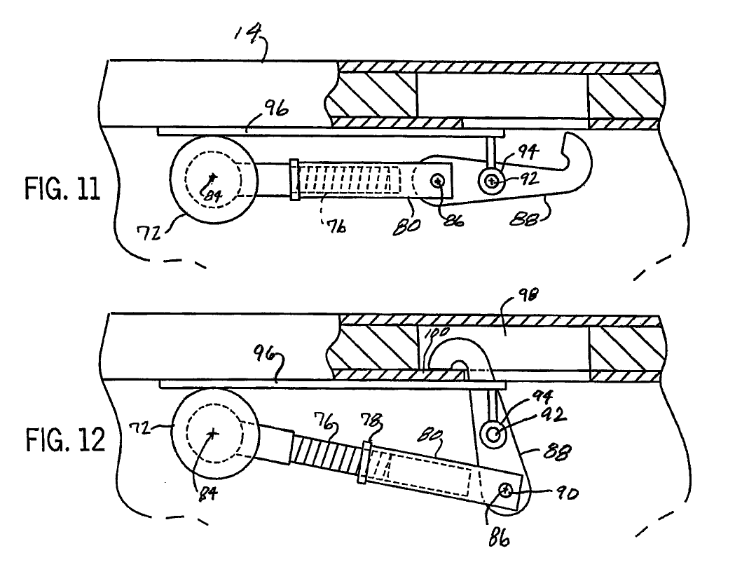

When the screw 76 is screwed into the nut 78, so as to shorten the distance between the axes 84 and 86, the locking arm element 88 moves to the position of FIG. 11 in which it is unlatched from the gate 14. When the screw is fully screwed into the nut 78, the pivot 86 is slightly outside of a line between the axis of pin 92 and axis 84. Thereby, extending the distance between the axes 84 and 86 by unscrewing the screw 76 from the nut 78 causes the element 88 to rotate counter-clockwise about pin 92 to the position of FIG. 12 in which the end of the element 88 is rotated into space 98 of gate 14 and behind a striker plate 100 of the gate 14. This will help pull or draw the gate 14 closed and the threaded connection of the screw 76 with the nut 78 acts as a lock to keep the element 88 in the latched position.

The invention provides a powered tailgate that can be run off of available vehicle 12 volt electrical systems using a conventional DC motor and gear box that can be controlled to be driven in either direction. Limit switches could be employed in the closed position to automatically turn off the unit 60, as they could also be provided to automatically turn it off when it is fully open or down acting as a ramp into the vehicle compartment. As disclosed, the hinge plates on both sides of the gate 14 are preferably driven to impart sufficient force for opening and closing the tailgate 14 in a controlled manner. The hinge plates 18 and 20 can be made as heavy-duty as necessary, as can the remainder of the drive train. The system uses a parallel shaft arrangement, of the shafts 44 and 54, to position the motor and most of the drive system away from the door, and provide a system that can be retrofitted to many types of existing tailgates. In this construction, the prime mover is preferably fixed to the vehicle chassis generally in the center of the chassis, forward of the tailgate and below the compartment of the vehicle, to be out of the way and unobtrusive, protected and accessible for maintenance.

In addition, limit switches can be incorporated into the system to sense the two positions of the latch 70 and turn off the motor when those positions are reached. There are also preferably manual switches, one for operating the tailgate and one for operating the latch, which can be operated to move those components between their extreme positions, or to stop them anywhere in-between. In addition, for example, one switch could be used to unlatch and open the tailgate, and another position of the switch or another switch could be used to close and latch the tailgate.

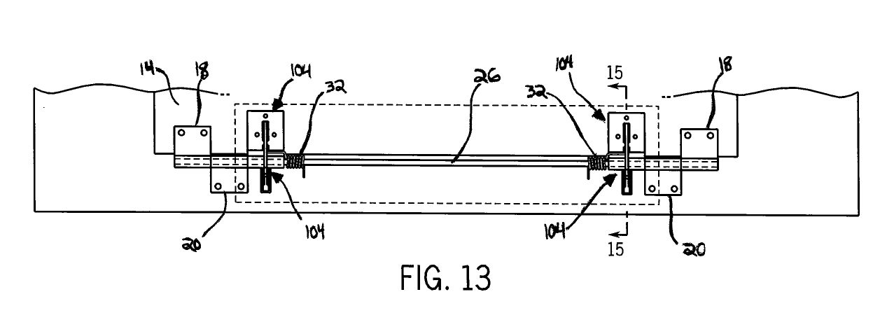

A second embodiment of the invention also attaches to the vehicle 10 described regarding the previous embodiment. The vehicle includes tailgate 14, upper hinge plates 18, lower hinge plates 20, hinge pin 26, and torsion springs 32 as shown in FIG. 13. These components are identical to those described in connection with the previous embodiment.

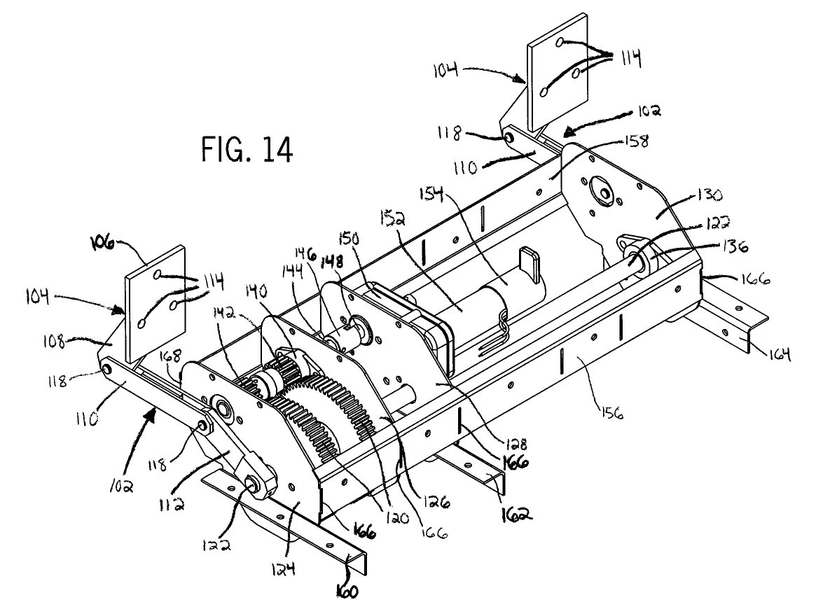

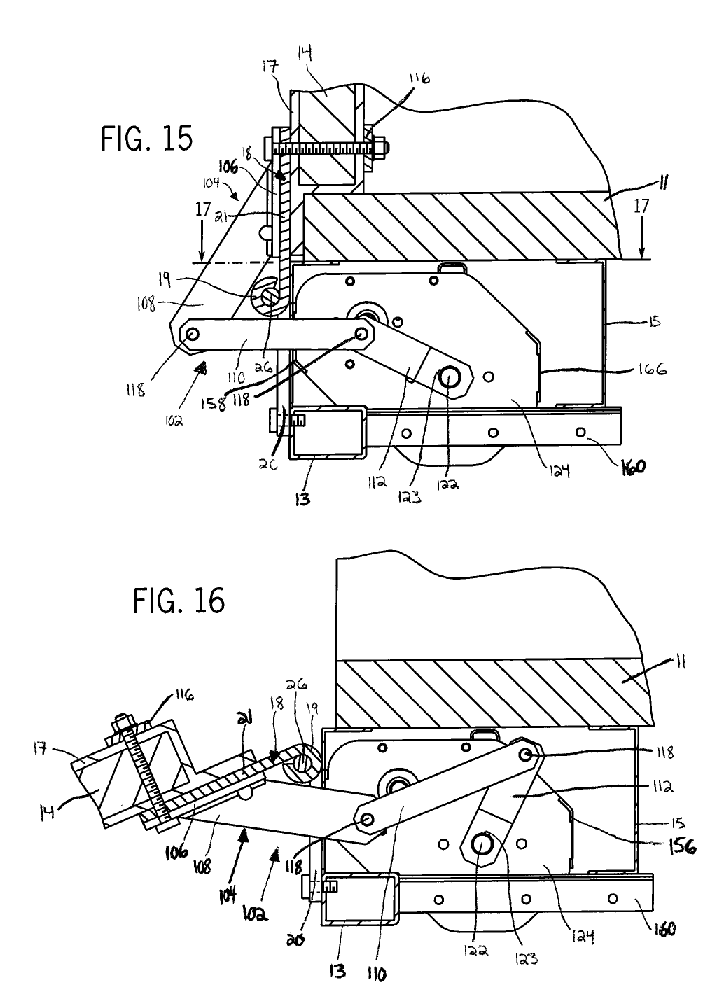

Referring to FIG. 14, the second embodiment of the invention includes two linkage assemblies 102. The linkage assembly 102 on the left side of FIG. 14 includes a hinge attachment member 104, a link 110, and a crank 112. The hinge attachment member 104 includes two sections, hinge attachment plate 106 and hinge attachment link 108. Hinge attachment plate 106 comprises a thin, flat, rectangular piece of material. Hinge attachment link 108 comprises a thin, flat strip of material. Hinge attachment plate 106 and hinge attachment link 108 may be welded together, formed as a single component, or connected using other well known methods. Hinge attachment plate 106 and hinge attachment link 108 should be connected such that the longitudinal axis of hinge attachment link 108 is rotated about 33° from the plane of hinge attachment plate 106. Hinge attachment plate 106 includes fastener holes 114 and is disposed rearward of and covers upper hinge plates 18, as best seen in FIG. 13. As shown in FIGS. 15 and 16, hinge attachment plate 106 is attached to the tailgate 14 by passing fasteners through fastener holes 114, upper hinge plates 18, the tailgate 14, a frame 17 of the tailgate 14, and a thin plate 116 on the opposite surface of the tailgate 14 relative to the hinge attachment plate 106. These components are secured by attaching washers and nuts to the fasteners.

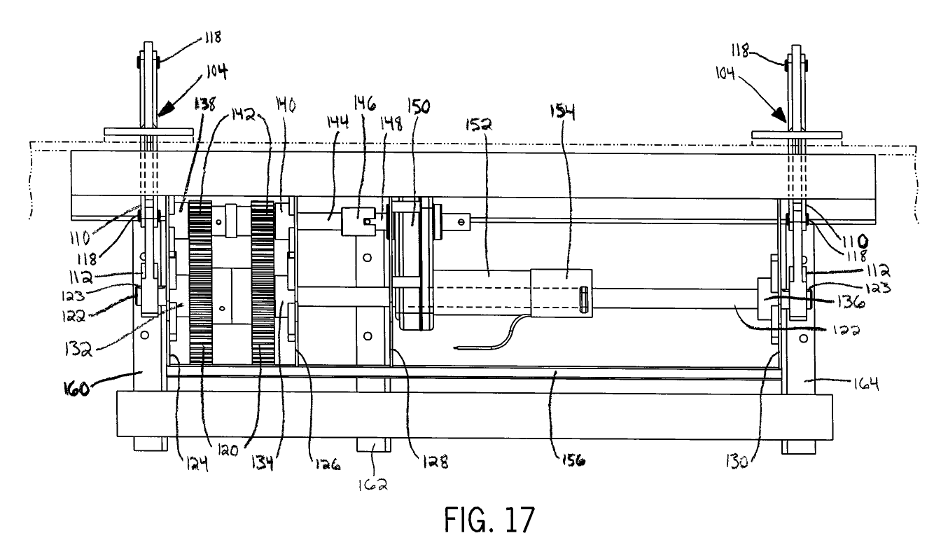

As shown in FIGS. 14-16, hinge attachment member 104 is pivotally attached to a distal end of the link 110 by a pin 118. The link 110 may comprise two thin, flat pieces welded together which form forked distal and proximal ends. The link 110 may also be a single component with forked distal and proximal ends. The proximal end of the link 110 is pivotally attached to a distal end of a crank 112 by a second pin 118. The distal end of the crank 112 is thinner than the proximal end of the crank 112 to connect to the forked proximal end of the link 110. The proximal end of the crank 112 is thick to accommodate a key 123 and connects to a set of driven gears 120 by a shaft 122. The set of driven gears 120 is attached to shaft 122 by set screws and keys (not shown). Therefore, crank 112 and the set of driven gears 120 do not rotate independently. Alternatively, the crank 112 and the set of driven gears 120 may be secured to the shaft 122 by welding, splines, other well known methods. As shown in FIG. 17, the crank 112 is separated from the set of driven gears 120 by a first bracket 124 and a first bearing 132 fastened to the first bracket 124 which supports the shaft 122. The shaft 122 is also supported by a second bearing 134 fastened to a second bracket 126 and a third bearing 136 fastened to a fourth bracket 130. On the side of the fourth bracket 130 opposite the third bearing 136, the shaft 122 connects to a second linkage 102.

As shown in FIGS. 14 and 17, the set of driven gears 120 is in meshing engagement with a set of driving gears 142 connected to a shaft 144. Alternatively, gears 120 and 142 could be replaced by chain and sprocket sets. The shaft 144 is supported by a fourth bearing 138 on the first bracket 124 and a fifth bearing 140 on the second bracket 126. On the side of the second bracket 126 opposite the set of driving gears 142, a coupling 146 connects the shaft 144 to an output shaft 148 from a gearbox 150. The gearbox 150 is fastened to a third bracket 128 on the side of the third bracket 128 opposite the coupling 146. The gearbox 150 is connected to the output shaft (not shown) of a motor unit 152 with a speed controller 154. The speed controller 154 controls the opening speed of the tailgate 14 and may be a pulse width modulation controller. Motion of the tailgate 14 due to the speed controller 154 is explained further below.

As best seen in FIG. 14, brackets 124, 126, 128, and 130 are commonly connected by a front bracket 156 and a rear bracket 158. Brackets 124, 126, 128, and 130 each include a front ear 166 and a rear ear 168 which are accommodated in slots in the front bracket 156 and rear bracket 158, respectively. Front ears 166 and rear ears 168 are also welded in the slots. Alternatively, brackets 124, 126, 128, and 130 may be connected to front bracket 156 and rear bracket 158 by fasteners or other well known methods. First bracket 124, second bracket 126, and fourth bracket 130 are fastened to a first angle bracket 160, a second angle bracket 162, and a third angle bracket 164, respectively. Each angle bracket 160, 162, and 164 comprises a thin piece of material with two sections disposed at about 90° from each other. As shown in FIGS. 15 and 16, angle brackets 160, 162, and 164 are fastened to a support rail 15 of the chassis 11. Alternatively, angle brackets 160, 162, and 164 may be connected to the support rail 15 by any suitable means, such as welding, locking tabs, or other well known methods. As shown in FIGS. 15 and 16, first bracket 124 and first angle bracket 160 engage a rear support rail 13 of the chassis 11. Brackets 126, 128, and 130 and angle brackets 162 and 164 also engage rear support rail 13 of the chassis 11. Alternatively, front bracket 156 and rear bracket 158 may include small angle brackets which connect to the support rail 15. Other means may be used, such as fastening the front bracket 156 and the rear bracket 158 directly to the chassis, depending on the size of the vehicle.

In addition to the linkage assemblies 102, a number of components of the second embodiment of the invention may be identical to reduce the number of types of components. As best seen in FIG. 14, brackets 124, 126, 128, and 130 may be identical. Angle brackets 160, 162, and 164 may be identical. Front bracket 156 and rear bracket 158 may be identical. Lastly, bearings 132, 134, 136, 138, and 140 maybe identical.

The orientation of the linkage assembly components with the tailgate open and closed are as follows. When the tailgate 14 is closed, as shown in FIG. 15, hinge attachment plate 106 is perpendicular relative to the chassis 11. Hinge attachment link 108 extends rearward and downward from the end connected to hinge attachment plate 106 to the attached pin 118. Link 110 extends frontward from the distal end to the proximal end and generally in the longitudinal direction of the chassis 11. Crank 112 extends frontward and downward from the distal end to the proximal end. In general, when the tailgate 14 is closed, the smallest angle between link 110 and crank 112 should be greater than 135° and less than 180°. The angle should be greater than 135° so the motor unit 152 will not be easily back-driven due to the weight of the tailgate 14 when the tailgate 14 is near the closed position. The angle should be less than 180° so the tailgate 14 can be lowered manually by a user in the event of a power failure.

When opening the tailgate 14, crank 112 rotates such that the distal end moves upwards and frontward. When the tailgate is open, as shown in FIG. 16, hinge attachment plate 106 extends rearward and downward from the end near hinge pin 26 to the end fastened to the tailgate 14. Hinge attachment link 108 extends frontward and downward from the end connected to hinge attachment plate 106 to the attached pin 118. Link 110 extends frontward and upward from the distal end to the proximal end. Crank 112 extends rearward and downward from the distal end to the proximal end. When moving from the closed position to the open position, the smallest angle between link 110 and crank 112 should never be 180°. That is, link 110 and crank 112 should never be aligned. Moving through an aligned position would cause a motion change for the tailgate 14.

Like the first embodiment of the invention, most components of the second embodiment of the invention are located forward of the tailgate and below the compartment of the vehicle. In addition, the second embodiment of the invention may be powered by a 12V electrical system of the vehicle and may include a latch for securing the tailgate, limit switches to sense the position of the latch, and manual switches for operating the tailgate and the latch. A thin plate may be used as a splash guard and may be positioned below brackets 124, 126, 128, and 130.

Several types of sensors may be used to control motion of the tailgate. Preferably, a current sensor is used to detect sudden current increases in the system. Such increases would occur if the tailgate has contacted the ground or the vehicle rear end when opening or closing, respectively. If the current exceeds a threshold value for a preset time period, the current sensor sends a signal to a controller to stop motion of the tailgate.

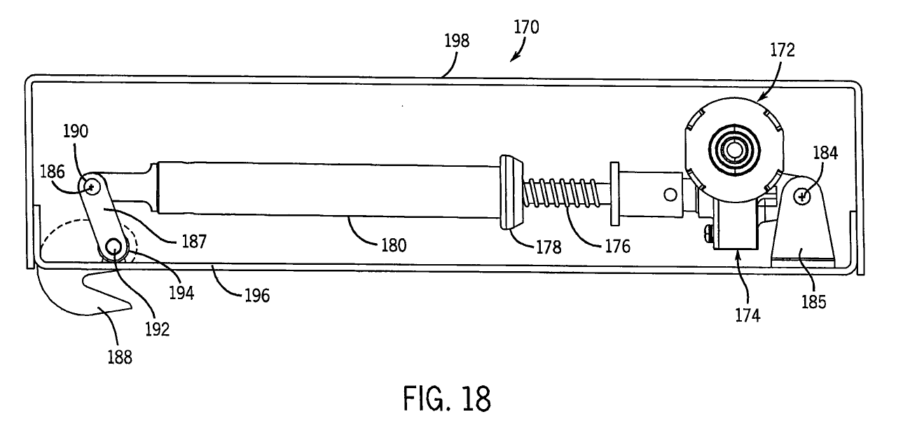

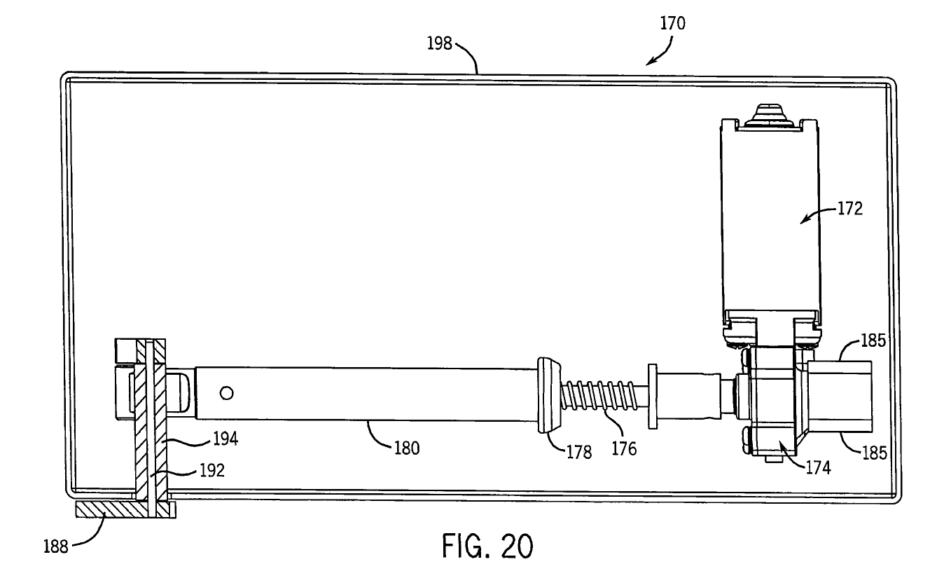

A second embodiment of a latch 170 is shown in FIGS. 18-20. The latch 170 includes several components similar to those of the first embodiment of the latch 70, including a motor gear box unit 172, a right angle drive 174, a lead screw 176, a nut 178, and a tube 180. Like the first embodiment of the latch 70, the motor gear box unit 172 drives the right angle drive 174, which in turn drives the lead screw 176 that is in threaded engagement with the nut 178 that is fixed to the tube 180. Turning the screw 176 into or out of the nut 178 varies the distance between axis 184 and axis 186. Axis 184 is the axis about which the motor gear box unit 172, the right angle drive 174, the lead screw 176, the nut 178, and the tube 180 commonly rotate. Axis 184 is located at the pivot point of a hinge 185 which is fixed relative to a base plate 196. Axis 186 is the axis about which a link 187 rotates relative to the tube 180. The link 187 is pivotally connected to tube 180 by a pin 90 which passes through holes in the link 187 and the tube 180. The link 187 is pivotally fixed to a locking arm member 188 by a post 192. The post 192 is pivotally connected to a tube 194 which is fixed relative to the base plate 196. The latch assembly 170 is preferably enclosed by a cover plate 198 which is fixed to the base plate 196. The base 196 plate is fixed to the chassis.

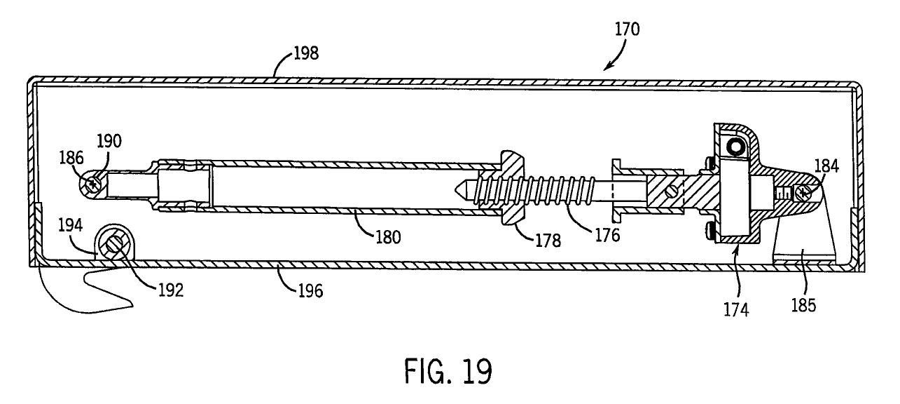

When the screw 176 is screwed into the nut 178, so as to shorten the distance between the axes 184 and 186, the locking arm member 188 moves to a position in which it is unlatched from the tailgate (not shown). Extending the distance between the axes 184 and 186 by unscrewing the screw 176 from the nut 178 causes the locking arm member 188 to rotate about pin 192 to the position of FIGS. 18 and 19 in which the locking arm member 188 engages the tailgate. This helps pull the tailgate closed and the threaded connection of the screw 176 with the nut 178 acts as a lock to keep the locking arm member 188 in the latched position.

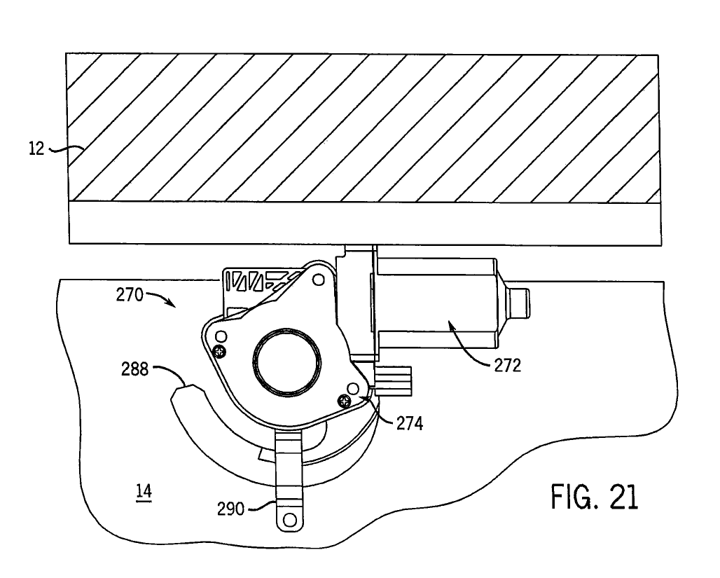

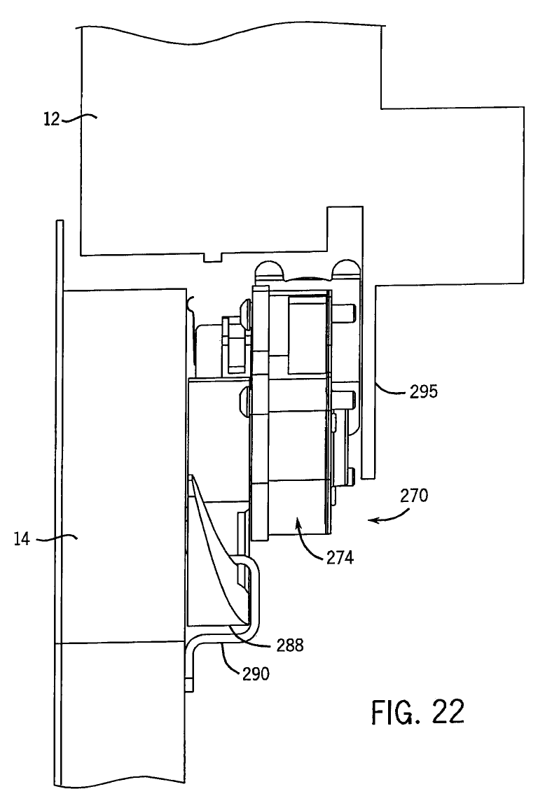

A third embodiment of a latch 270 is shown in FIGS. 21 and 22. The latch 270 includes several components similar to those of the previous embodiments of the latch, including a motor gear box unit 272 and a right angle drive 274. The right angle drive 274 could be a worm gear drive or a bevel gear drive. The latch 270 is fixed to a protruding surface 295 of the rear end 12 of the vehicle. The motor gear box unit 272 drives the right angle drive 274, which in turn drives a latch hook 288. The latch hook 288 is generally C-shaped and is thicker near the area connected to the right angle drive 274. The latch hook 288 also tapers as best seen in FIG. 22. The latch hook 288 passes through the space between the tailgate 14 and a latch bracket 290 fixed to the tailgate 14. The latch bracket 290 is a thin U-shaped piece of material which accommodates the latch hook 288.

When the tailgate 14 is moved to the closed position, the latch hook 288 is rotated clockwise to the position shown in FIG. 21. The tapered surface of the latch hook 288 forces the latch bracket 290 and the tailgate 14 forward as the latch hook 288 rotates. This effectively creates a seal between the tailgate 12 and the rear end 14 of the vehicle. To move the tailgate 12 to the open position, the latch hook 288 is rotated counter-clockwise to disengage the latch bracket 290.

The second and third embodiments of the latch 170 and 270 may include limit switches to sense the position of the latch in a similar fashion to that of the first embodiment of the latch 70. All embodiments of the latch may also be controlled by a controller which ensures the latch is disengaged before opening the tailgate. In addition, for all embodiments of the latch, multiple latches may be used. For example, two latches may be used which are located near the sides of the top of the opening for the tailgate. In this case, a single motor may be used to power both lock mechanisms. Using multiple latches may prevent bending and warping of the tailgate. A manual exterior latch may also be included to positively hold the door closed and prevent undesired entry.

For both embodiments of the tailgate ramp assembly, the motor drive operates at fall power through the entire range of motion and is assisted by the torsion springs. When opening the tailgate, the drive motor needs to overcome the resisting torque applied by the torsion springs. However, the torque due to the weight of the tailgate changes as the tailgate opens. Therefore, using a constant power setting would cause the tailgate to quickly strike the ground. Instead, different amounts of power are supplied to the motor in four phases when opening the tailgate. In the first opening phase, the drive motor operates at full power to start moving the tailgate. In the second opening phase, the drive motor is powered intermittently by repetitively grounding the motor leads. This achieves a pulsating brake effect. In addition, the motor may include an internal or external brake to further facilitate the pulsating brake effect. In the third opening phase, little power is supplied to the motor relative to the first phase, and the weight of the tailgate almost completely causes its motion. In the fourth opening phase, the motor is powered and braked like the second opening phase, but less power is supplied. The length of each phase may be a specified time period or preset rotation angle of the drive motor. A well known sensor, such as a hall effect sensor, could be used to measure the rotation angle of the drive motor. In addition, the tailgate could include a separate speed transducer to measure the rotation speed and angle of the tailgate.

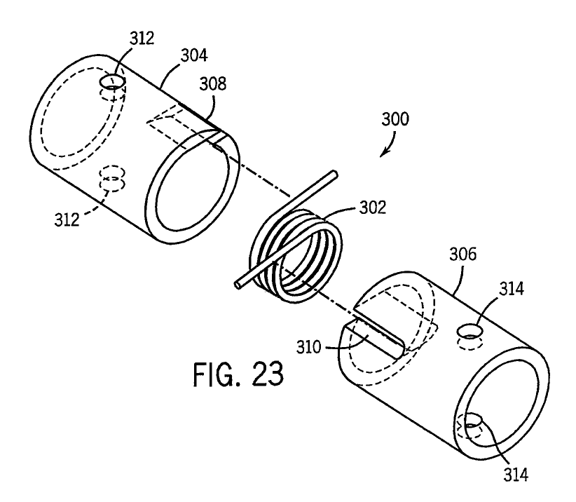

The tailgate ramp assembly may also include torsion spring universal joints 300 as shown in FIG. 23. Such a device may be used if the motor unit 152 has a braking mechanism or sufficient internal friction to prevent freewheeling motion. Each torsion spring universal joint 300 includes a torsion spring 302 and couplings 304 and 306. Couplings 304 and 306 may be identical. Couplings 304 and 306 include respective slots 308 and 310 to accommodate the ends of the torsion spring. Couplings 304 and 306 also include respective holes 312 and 314 for pins (not shown) to connect couplings 304 and 306 to separate sections of a shaft.

When used in conjunction with the second embodiment of the invention, a single torsion spring universal joint 300 may be used to replace the coupling 146 between the output shaft 148 from the gearbox 150 and the shaft 144 connected to the set of driving gears 142. Alternatively, two torsion spring universal joints 300 may be used to separate the shaft 122 connected to the set of driven gears 120 into three sections. In this case, the torsion spring universal joints 300 would be located near the cranks 112 on opposite sides of the assembly.

The torsion spring 302 is preloaded such that the torsion spring universal joint 300 acts as a rigid member until torque is transmitted in excess of the preload. The torque required to raise or lower the tailgate should not exceed the preload. For example, a preload of 1000 in-lbs may be sufficient depending on the size of the components of the vehicle and the power output of the drive motor. The torsion spring 302 rotates up to a maximum torque or a maximum angle. When using a preload of 1000 in-lbs, appropriate values for maximum torque and maximum angle are 2000 in-lbs and 30°, respectively. Torsion spring universal joints 300 reduce the transmission of shock loads from the tailgate to the drive system components. Such a shock load is imparted to the tailgate when a vehicle or other large object enters or is removed from the storage compartment. If the torque due to the shock load is greater than the preload of the torsion spring 302, the torsion spring 302 rotates, thereby protecting the drive system components from the shock load. In addition, torsion spring universal joints 300 may prevent the vehicle 10 or an attached towing vehicle from being rotated by pitching motion when the tailgate is subjected to a shock load, such as when a vehicle drives on the ramp and the suspension of the vehicle 10 is suddenly compressed.

Several embodiments of the invention have been described in considerable detail. Many modifications and variations to these embodiments will be apparent to a person of ordinary skill in the art. Therefore, the invention should not be limited to the embodiments described.

We claim:

1. In a tailgate ramp assembly for a vehicle that has a tailgate closeable over an opening into the vehicle with a hinge to the vehicle chassis at a lower edge of the opening to pivot about a horizontal pivot axis with the tailgate serving as a ramp from the ground into the vehicle through the opening when the tailgate is open, the improvement wherein:
the tailgate ramp assembly includes:
a hinge plate fixed to the tailgate for pivoting about the pivot axis;
a rotary mechanism for rotating the tailgate open and closed about the pivot axis, the mechanism including a rotary motor, a reducing drivetrain and an output shaft;
wherein the door is driven to pivot about the pivot axis by a the output shaft of the mechanism.

2. A tailgate ramp assembly as in claim 1, wherein the mechanism includes a linkage assembly.

3. A tailgate ramp assembly as in claim 2, wherein the linkage assembly includes a plate for covering at least one hinge.

4. A tailgate ramp assembly as in claim 1, wherein the mechanism includes a coupling.

5. A tailgate ramp assembly as in claim 1, wherein a hinge pin is inserted in the hinge plate and is also inserted in a hinge plate that is fixed to the vehicle chassis.

6. A tailgate ramp assembly as in claim 1, wherein at least one hinge plate is driven by the mechanism.

7. A tailgate ramp assembly as in claim 1, wherein hinge plates on both ends of the tailgate are driven.

8. A tailgate ramp assembly as in claim 1, wherein the mechanism includes a driven gear that is a spur gear and a driver gear that is a spur gear.

9. A tailgate ramp assembly as in claim 1, further comprising a latch driven by a rotary electric motor.

10. A tailgate ramp assembly as in claim 7, wherein the latch includes a power driven screw engaged with a nut.

11. A tailgate ramp assembly as in claim 8, wherein the screw and nut rotate an arm that latches the door shut.

12. A tailgate ramp assembly as in claim 1, wherein the tailgate is at least opened in part using a pulsating brake method.

13. In a tailgate ramp assembly for a vehicle that has a tailgate closeable over an opening into a compartment of the vehicle with a hinge to the vehicle chassis at a lower edge of the opening to pivot about a horizontal pivot axis with the tailgate serving as a ramp from the ground into the vehicle through the opening when the tailgate is open, the improvement wherein:
the tailgate ramp assembly includes:
a mechanism for engaging the tailgate to rotatably drive the tailgate so as to open and close the tailgate;
a first shaft in driving engagement with the mechanism; and
a second shaft parallel to the first shaft in driving engagement with the first shaft and driven by a rotary motor so as to drive the first shaft.

14. A tailgate ramp assembly as claimed in claim 13, wherein the mechanism is a linkage assembly.

15. A tailgate ramp assembly as claimed in claim 14, wherein the linkage assembly includes a plate for covering at least one hinge.

16. A tailgate ramp assembly as claimed in claim 13, wherein the mechanism includes a coupling.

17. A tailgate ramp assembly as claimed in claim 13, wherein the motor is positioned forward of the tailgate.

18. A tailgate ramp assembly as claimed in claim 13, wherein the motor is below the compartment of the vehicle.

19. A tailgate ramp assembly as claimed in claim 13, wherein the motor includes a rotary motor.

20. A tailgate ramp assembly as claimed in claim 13, wherein both ends of the tailgate are driven.

21. A tailgate ramp assembly as claimed in claim 13, wherein the first shaft and the second shaft are supported by a set of brackets.

22. A tailgate ramp assembly as claimed in claim 21, wherein the set of brackets includes identical brackets.

23. A tailgate ramp assembly as claimed in claim 19, wherein the rotary motor connects to a speed controller.

24. A tailgate ramp assembly as claimed in claim 23, wherein the speed controller is a pulse width modulation controller.

25. A tailgate ramp assembly as claimed in claim 13, wherein the tailgate is at least opened in part using a pulsating brake method.
